(19) United States
(12) Patent Application Publication
(10) Pub. No.: US 2024/0045921 A1
(43) Pub. Date: Feb. 8, 2024

(54) PARAMETER ESTIMATION APPARATUS, AGGREGATED DATA RESOLUTION ENHANCEMENT APPARATUS, PARAMETER ESTIMATION METHOD, AGGREGATED DATA RESOLUTION ENHANCEMENT METHOD AND PROGRAM

(71) Applicant: NIPPON TELEGRAPH AND TELEPHONE CORPORATION, Tokyo (JP)

(72) Inventors: Yusuke TANAKA, Tokyo (JP); Tomoharu IWATA, Tokyo (JP); Takeshi KURASHIMA, Tokyo (JP); Hiroyuki TODA, Tokyo (JP)

(21) Appl. No.: 18/255,925

(22) PCT Filed: Dec. 10, 2020
(86) PCT No.: PCT/JP2020/046123

§ 371 Date: Jun. 5, 2023

(51) Int. Cl. G06F 17/11

(52) U.S. Cl. CPC G06F 17/11

(57) ABSTRACT

A parameter estimation device for estimating a plurality of parameters used for calculating high-resolution data from aggregated data aggregated to coarse granularity, the parameter estimation device comprising: a parameter estimation unit configured to estimate a plurality of parameters that are unknown variables in a model so as to maximize a marginal likelihood based on the assumption that actually observed aggregated data is generated from the model based on a multivariate Gaussian process in which a plurality of latent Gaussian processes for a plurality of types of aggregated data in a plurality of domains are represented by linear mixing; and a storage unit configured to store the plurality of parameters, wherein the plurality of parameters include a hyperparameter of a prior distribution to a mixing coefficient used in the linear mixing.

### TECHNICAL FIELD

The present invention relates to a technique for estimating high resolution data from aggregated data aggregated to coarse granularity.

### BACKGROUND ART

In recent years, various types of spatial data (poverty level, air pollution level, number of crimes, population, traffic volume, etc.) are collected and published by governments and companies for the purpose of improving the urban environment and businesses. The spatial data refers to data given as a pair of position information (such as a latitude and a longitude) and some value associated with the position information.

However, such spatial data involves a high collection cost and it is difficult to secure a sufficient number of samples. For this reason, in many cases, the spatial data is provided in an aggregated manner in a relatively coarse-grained area (address, region, etc.) Such data is hereinafter referred to as “aggregated data.” In order to improve the urban environment more effectively, it is desirable to obtain data with as high resolution as possible. For example, more appropriate intervention can be performed by narrowing in detail areas of high poverty or high air pollution.

Therefore, the problem of predicting high-resolution data from low-resolution aggregated data is important. In the prior art, various types of aggregated data, each with its own resolution, are prepared separately from target low-resolution aggregated data, and are modeled simultaneously based on a multivariate Gaussian process, to realize highly accurate prediction of low-resolution data (see NPL 3). Further, an attempt has been made to utilize data in a different domain (such as a city) (NPL 2).

### CITATION LIST

### Non Patent Literature

[NPL 1] D. Kingma and M. Welling. Auto-encoding variational Bayes. In ICLR, 2014.
[NPL 2} Y. Tanaka, T. Tanaka, T. Iwata, T. Kurashima, M. Okawa, Y. Akagi, and H. Toda. Spatially aggregated Gaussian processes with multivariate areal outputs. In NeurIPS, pages 3000-3010, 2019.
[NPL 3] F. Yousefi, M. T. Smith, and M. A.' Alvarez. Multi-task learning for aggregated data using Gaussian processes. In NeurIPS, pages 15050-15060, 2019.8

### SUMMARY OF INVENTION

### Technical Problem

In the prior art disclosed in NPL 2 and NPL 3, a plurality of kinds of aggregated data are simultaneously modeled on the basis of a multivariate Gaussian process, to predict target high-resolution data. In so doing, in the technique disclosed in NPL 2, even when domain (such as cities) are different, the parameters of the Gaussian process are shared between the domains to utilize data in a plurality of domains. However, this technique has a problem that the similarity between domains cannot be considered.

That is, the prior art assumes that, even if a set of data of the same type exists in different domains, the strength of the dependence between these data is independent for each domain. However, depending on the domain, only low-resolution data are obtained. In such a case, it is difficult to appropriately estimate the strength of the dependence between data.

The present invention was contrived in view of the above and an object thereof is to realize highly accurate prediction of high-resolution data by utilizing various types of data in a plurality of domains.

### Solution to Problem

The disclosed technique provides a parameter estimation device for estimating a plurality of parameters used for calculating high-resolution data from aggregated data aggregated to coarse granularity, the parameter estimation device including: a parameter estimation unit configured to estimate a plurality of parameters that are unknown variables in a model so as to maximize a marginal likelihood based on the assumption that actually observed aggregated data is generated from the model based on a multivariate Gaussian process in which a plurality of latent Gaussian processes for a plurality of types of aggregated data in a plurality of domains are represented by linear mixing; and a storage unit configured to store the plurality of parameters, wherein the plurality of parameters include a hyperparameter of a prior distribution to a mixing coefficient used in the linear mixing.

### Advantageous Effects of Invention

According to the disclosed technique, highly accurate prediction of high-resolution data can be realized by utilizing various types of data in a plurality of domains.

### BRIEF DESCRIPTION OF DRAWINGS

FIG. 1 is a configuration diagram of an aggregated data resolution enhancement device according to an embodiment of the present invention.

FIG. 2 is a diagram showing an example of a hardware configuration of the device.

FIG. 3 is a diagram for explaining an overall processing flow.

FIG. 4 is a diagram showing an example of retrieval to a retrieval unit and an example of output from an output unit according to the embodiment of the present invention.

### DESCRIPTION OF EMBODIMENTS

Hereinafter, an embodiment of the present invention (the present embodiment) will be described with reference to the drawings. The embodiment to be described below is merely exemplary and embodiments to which the present invention is applied are not limited to the following embodiment.

### Overview of Embodiment

In order to solve the problem of the prior art that the similarity between domains cannot be considered, the present embodiment introduces a prior distribution for a parameter (mixing coefficient) representing the dependence between data is introduced, and introduces a parameter estimation means is introduced in which the prior distribution is taken into consideration. Thus, highly accurate prediction of high-resolution data can be realized by utilizing various types of data in a plurality of domains while simultaneously estimating similarity between the domains. More specifically, the following means 1 and 2 are introduced.

(1) Means 1: Multivariate Gaussian Process Model for Aggregated Data where Prior Distribution for Mixing Coefficient is Introduced

In the means 1, a “spatial scale parameter,” a “mixing coefficient,” a “parameter for noise,” and a “hyperparameter for prior distribution” are used as unknown variables, and, on the basis of a multivariate Gaussian process expressed by linear mixing of a plurality of latent Gaussian processes, the value of the aggregated data is modeled by an integral value of the Gaussian process in the corresponding region. Assuming that actually observed aggregated data is generated from the above-mentioned model, the unknown variables are estimated so as to maximize the marginal likelihood.

The effects of the means 1 are as follows.

Based on a multivariate Gaussian process model expressed by linear mixing of a plurality of latent Gaussian processes, a plurality of pieces of data in each domain are simultaneously modeled, and a prior distribution for the mixing coefficient is introduced. As a result, the “spatial scale parameter” and the “mixing coefficient” can be learned by utilizing the data in the plurality of domains while estimating the similarity between the domains.

### (1) Means 2: Efficient Parameter Estimation Means by Variational Bayesian Method

In the means 2, an unknown variable is estimated based on a variational Bayesian method in addition to the multivariate Gaussian process model in the means 1.

The effects of the means 2 are as follows.

In estimating an unknown variable, it is necessary to calculate a marginal likelihood, but it is actually difficult to analytically calculate the marginal likelihood. Therefore, use of an arbitrary approximate estimation means is considered, but a learning method based on the variational Bayesian method is derived as one of the choices. This allows for efficient learning of unknown variables.

An aggregated data resolution enhancement device 100 (aggregated data resolution enhancement apparatus) incorporating the above-mentioned means is provided in the present embodiment. The aggregated data resolution enhancement device 100 can be applied to all data aggregated in an arbitrary region (referred to as aggregated data hereinafter for simplicity), and can flexibly handle the type of data to be used (such as poverty levels, air pollution levels, traffic volume) and the dimension number d∈{1, . . . } of the data input space without relying on them, to estimate high-resolution data.

v=1, . . . V is the argument of a domain, and let Sᵥ is the set of data types in the v-th domain.

Here, assuming that the total set of data type sets in all domains is S, Sᵥ⊂S. Hereinafter, for the sake of simplicity, assuming that there are S types of data in all domains, where s=1, . . . is formulated with S as the argument of data type. However, even if the type of data obtained by the domain is different as described above, the formulation can be similarly performed.

The aggregated data resolution enhancement device 100 according to the present embodiment models a value of aggregated data by an integral value of a Gaussian process in a corresponding region on the basis of a multivariate Gaussian process model expressed by linear mixing of a plurality of latent Gaussian processes, sets a prior distribution to a mixing coefficient, estimates an unknown variable on the basis of a variational Bayesian method, and predicts high-resolution data.

The configuration and operation of the aggregated data resolution enhancement device 100 will be described hereinafter in detail. Although data aggregated in a two-dimensional space as aggregated data will be mainly described as an example below, the present invention can be applied to data aggregated in a space having an arbitrary number of dimensions. For example, when a one-dimensional space is considered, the time series data such as sensor data are aggregated at arbitrary time intervals.

### (Example of Device Configuration)

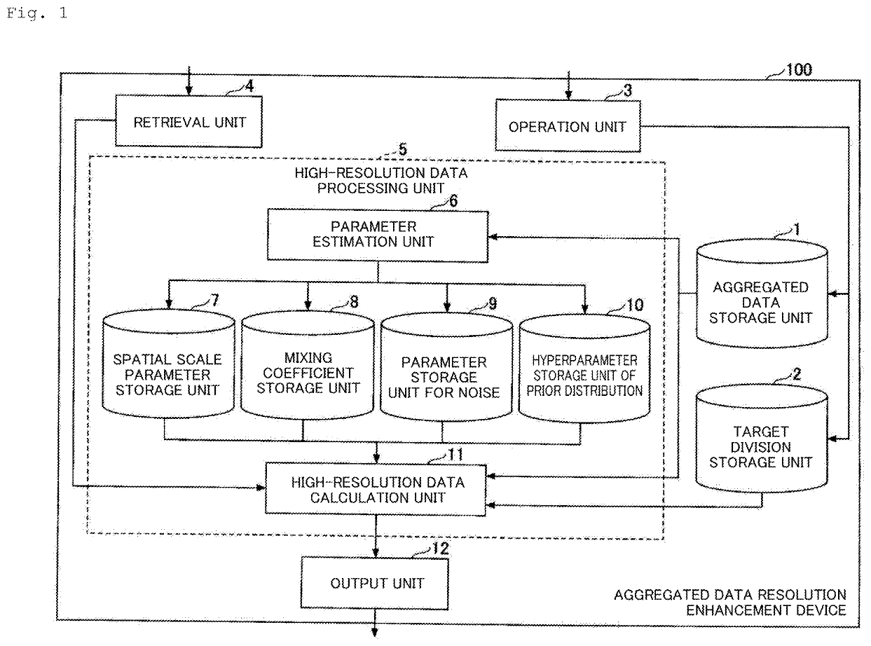

FIG. 1 shows a configuration example of the aggregated data resolution enhancement device 100 according to the present embodiment. The aggregated data resolution enhancement device 100 shown in the diagram includes an aggregated data storage unit 1, a target division storage unit 2, an operation unit 3, a retrieval unit 4, a high-resolution data processing unit 5, a parameter estimation unit 6, a spatial scale parameter storage unit 7, a mixing coefficient storage unit 8, a parameter storage unit 9 for noise, a hyperparameter storage unit 10 of a prior distribution, a high-resolution data calculation unit 11, and an output unit 12. The operation of each unit will be described hereinafter in detail.

The aggregated data resolution enhancement device 100 may be constituted by a plurality of devices (computers) or a single device. Further, the aggregated data resolution enhancement device 100 may be called an aggregated data resolution enhancement system. The aggregated data resolution enhancement device 100 may also be called a parameter estimation device (parameter estimation apparatus). In FIG. 1, a device comprising functional units other than the aggregated data storage unit 1 and the target division storage unit 2 may be called an aggregated data resolution enhancement device 100.

Further, a device that does not include a function for improving the resolution but includes a function for estimating parameters (that is, the parameter estimation unit 6) may be called a parameter estimation device. In addition, a device that does not include a function for estimating parameters but includes a function for achieving high resolution (that is, the high-resolution data calculation unit 11) may be called an aggregated data resolution enhancement device.

### (Example of Hardware Configuration)

Both the aggregate data resolution enhancement device and the parameter estimation device (collectively referred to as “device”) described above can be realized, for example, by having a computer execute a program that describes the processing contents described in the present embodiment. Note that the “computer” may be a physical machine or a virtual machine in the cloud. When using a virtual machine, the “hardware” described here is virtual hardware.

The program can be recorded on a computer-readable recording medium (a portable memory or the like), stored, and distributed. It is also possible to provide the program through a network such as the Internet or e-mail.

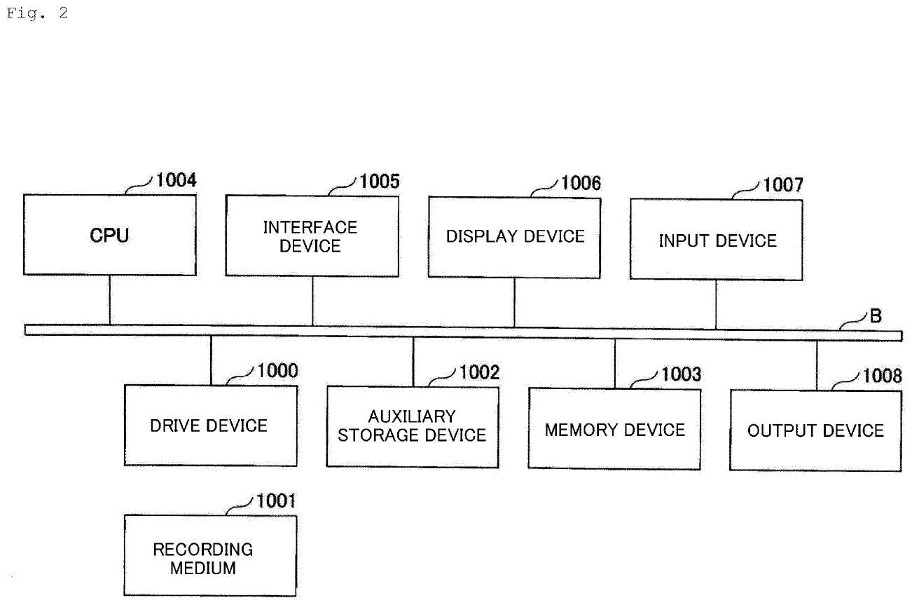

FIG. 2 is a diagram showing an example of a hardware configuration of the above computer. The computer in FIG. 2 includes a drive device 1000, an auxiliary storage device 1002, a memory device 1003, a CPU 1004, an interface device 1005, a display device 1006, an input device 1007, and an output device 1008 which are connected to each other via a bus B.

A program for realizing processing in the computer is provided by, for example, a recording medium 1001 such as a CD-ROM or a memory card. When the recording medium 1001 having the program stored therein is set in the drive device 1000, the program is installed in the auxiliary storage device 1002 from the recording medium 1001 via the drive device 1000. However, the program does not necessarily have to be installed from the recording medium 1001, and may be downloaded from another computer via a network. The auxiliary storage device 1002 stores the installed program and also stores necessary files, data, and the like.

The memory device 1003 reads and stores the program from the auxiliary storage device 1002 when there is an instruction to start the program. The CPU 1004 implements a function related to the device in accordance with the program stored in the memory device 1003. The interface device 1005 is used as an interface for connection to a network. The display device 1006 displays a GUI (Graphical User Interface) (GUI) or the like according to the program. The input device 1007 is configured by a keyboard, a mouse, buttons, a touch panel, or the like, and is used to input various operation instructions. The output device 1008 outputs a calculation result.

### (Processing Operation of Aggregated Data Resolution Enhancement Device 100)

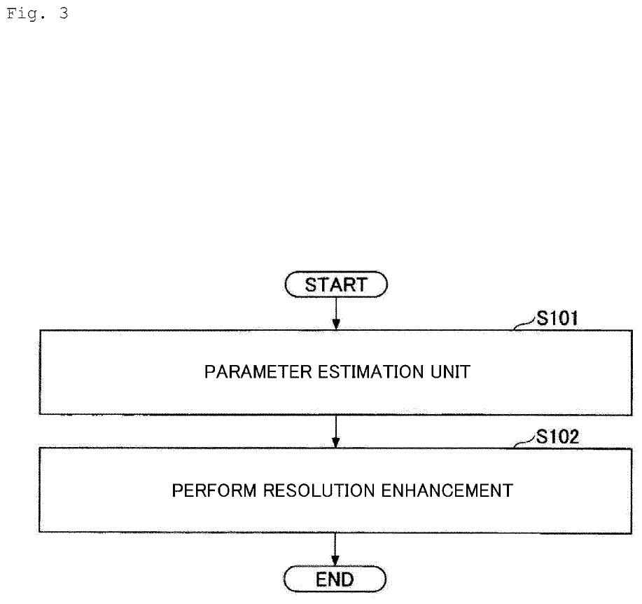

First, an overall processing flow will be described with reference to FIG. 3.

In S101, the parameter estimation unit 6 models a value of the aggregated data by an integral value of a Gaussian process in a corresponding region on the basis of a multivariate Gaussian process model expressed by linear mixing of a plurality of latent Gaussian processes, sets a prior distribution for a mixing coefficient, and then estimates a plurality of parameters which are unknown variables, on the basis of the variational Bayesian method.

In S102, the high-resolution data calculation unit 11 calculates high-resolution data from the aggregated data by using the plurality of parameters calculated in S101, and outputs the high-resolution data from the output unit 12.

The functions and processing operations of the respective units constituting the aggregated data resolution enhancement device 100 will be described below.

<Aggregated Data Storage Unit 1>

The aggregated data storage unit 1 stores data which can be analyzed by the aggregated data resolution enhancement device 100, reads the data according to a request from the high-resolution data processing unit 5, and transmits the corresponding data to the high-resolution data processing unit 5.

An input space in the v-th domain is taken as Xᵥ⊂R^{d}, and x∈Xᵥ is taken as an input variable. For example, in the case where d=2, Xᵥ corresponds to the entire v-th city, and x corresponds to a latitude and a longitude or the like. For the s-th data of the v-th domain, P_{VS} is represented by a division in which the corresponding data is associated. Here, the division corresponds to, for example, the division of cities by addresses and areas. Further, N_{VS} represents the number of regions included in the divided P_{VS}. For the argument n=1, . . . , Nᵥₛ, suppose that the n-th region is Rᵥₛₙ∈Pᵥₛ. The n-th observation included in the s-th data is expressed as (Rᵥₛₙ, yᵥₛₙ) with a pair of region Rᵥₛₙ and value yᵥₛₙ∈R. The data stored in the aggregated data storage unit 1 is as follows.

[Math. 1]

{(Rᵥₛₙ,yᵥₛₙ)|v=1, . . . ,V;s=1, . . . ,S;n=1, . . . ,Nᵥₛ} (1)

In other words, the aggregated data storage unit 1 stores regions and values for each domain, each type of data, and each region. The aggregated data storage unit 1 can be realized specifically by, for example, a web server, a database server equipped with a database, or the like. The aggregated data storage unit 1 may be a storage device in one computer.

<Target Division Storage Unit 2>

The target division storage unit 2 stores division which can be output by the aggregated data resolution enhancement device 100, reads data in accordance with a request from the high-resolution data processing unit 5, and transmits the corresponding data to the high-resolution data processing unit 5. It is assumed that division having p^{target} as the target is represented. One of the regions included in the P^{target} is expressed as R^{target}. Here, the target division can be an arbitrary one, and division based on an address and an area, or a mesh of an arbitrary size set by a user, can be considered. The target division storage unit 2 is realized by, for example, a web server, a database server equipped with a database, or the like. The target division storage unit 2 may be a storage device in one computer.

### <Operation Unit 3>

The operation unit 3 accepts, from a user, various types of operations for data stored in the aggregated data storage unit 1 and the target division storage unit 2. Various types of operations include registering, editing, and deleting of stored information. Input means of the operation unit 3 may be any input means by, for example, a keyboard, a mouse, a menu screen, or a touch panel. The operation unit 3 is realized by, for example, a device driver of the input means such as a mouse, and control software for a menu screen.

### <Retrieval Unit 4>

The retrieval unit 4 accepts a data type to be subjected to resolution enhancement, and target division. The high-resolution data predicted by the aggregated data resolution enhancement device 100 is output with respect to the data designated by the retrieval unit 4 and the target division. Input means of the retrieval unit 4 may be any input means by, for example, a keyboard, a mouse, a menu screen, or a touch panel. The retrieval unit 4 can be realized by a device driver of input means such as a mouse, and control software for a menu screen.

### <High-Resolution Data Processing Unit 5>

As shown in FIG. 1, the high-resolution data processing unit 5 includes a parameter estimation unit 6, a spatial scale parameter storage unit 7, a mixing coefficient storage unit 8, a parameter storage unit 9 for noise, a hyperparameter storage unit 10 of a prior distribution, and a high-resolution data calculation unit 11.

In the high-resolution data processing unit 5, the parameter estimation unit 6 estimates a space scale parameter, a mixing coefficient, a parameter for noise, and a hyperparameter of a prior distribution, with the data stored in the aggregated data storage unit 1 as learning data. Then, the high-resolution data predicted by using these parameters is output.

The high-resolution data processing unit 5 incorporates the unknown variable described above, models the aggregated data in the plurality of domains on the basis of a multivariate Gaussian process model expressed by linear mixing of a plurality of latent Gaussian processes, and estimates the unknown variable on the basis of the marginal likelihood when the observation data is given. Then, high-resolution data is calculated on the basis of the prediction distribution of the Gaussian process.

### <Parameter Estimation Unit 6>

The Gaussian process model and the parameter estimation method processed by the parameter estimation unit 6 will be described hereinafter in detail. First, a multivariate Gaussian process expressed by linear mixing of a plurality of latent Gaussian processes is formulated. Suppose that V×L independent Gaussian processes are as follows.

[Math. 2]

gᵥₗ(x)˜ [symbol] (0,γₗ(x,x′)),v=1, . . . ,V;l=1, . . . ,L (2)

Here, when X=X₁UX₂ . . . , UX_{V}, γ₁ (x, x′):X×X->R is the l-th correlation function, which can be anything. Here, the following correlation function is used.

$$\begin{matrix}[ Math . 3 ] & \\ {γ}_{l} ( x , {x}^{′} ) = exp ( - \frac{1}{2 {β}_{l}^{2}} {‖ x - {x}^{′} ‖}^{2} ) & ( 3 )\end{matrix}$$

Here, β₁ is a spatial scale parameter of the l-th correlation function. For v=1, . . . , V, fᵥₛ (x) is taken as a Gaussian process for the s-th aggregated data of each domain, and S-variate Gaussian process fᵥ (x)=(fᵥ₁ i(x), . . . , fᵥₛ(x))^{T} is expressed as linear mixing of L independent Gaussian processes as follows.

[Math. 4]

fᵥ(m)=Wᵥgᵥ(z)+nᵥ(m),v=1, . . . ,V (4)

Here, gᵥ(x)=(gᵥ₁(x), . . . , g_{vL}(x))^{T}, Wᵥ is a mixing matrix of S×L, and Wᵥₛₗ∈R which is (s, l) element represents a mixing coefficient. Further, nᵥ(x) represents a noise process for each piece of data, is a Gaussian process with an average S variable of 0, and is expressed as follows.

[Math. 5]

nᵥ(x)˜ [symbol] (0,Λᵥ(x,x′)),v=1, . . . ,V (5)

Here, vector 0 is a vector having 0 (zero) for all elements, and Λᵥ(x, x′) is expressed as follows.

[Math. 6]

Λᵥ(x,x′)=diag(λᵥ₁(x,x′), . . . ,λ_{vS}(x,x′)),v=1, . . . ,V (6)

λ_{VS}(x, x′):Xᵥ×Xᵥ→R is a correlation function of a noise process with respect to the s-th data of the v-th domain, and can be anything. Here, the following is used.

$$\begin{matrix}[ Math . 7 ] & \\ {λ}_{v s} ( x , {x}^{′} ) = {α}_{v s}^{2} exp ( - \frac{1}{2 {κ}_{v s}^{2}} {‖ x - {x}^{′} ‖}^{2} ) & ( 7 )\end{matrix}$$

The integral erasure can be performed for the gᵥ(x) and nᵥ(x) in the equation (4), and the S-variate Gaussian process can be written as follows.

[Math. 8]

fᵥ(x)˜ [symbol] (0,Kᵥ(x,x′)),v=1, . . . ,V (8)

Here, Kᵥ(x, x′):X×X→R^{s×s} represents a correlation matrix as follows.

[Math. 9]

Kᵥ(x,x′)=WᵥΓ(x,x′)Wᵥ^{T}+Λᵥ(x,x′),v=1, . . . ,V (9)

Here, Γ(x, x′)=diag (γ₁(x, x′), . . . , γ_{L}(x, x′)).

Next, a prior distribution for the mixing coefficient is introduced. The prior distribution for the mixing coefficient wᵥₛₗ is taken as wᵥₛₗ to p(wₛₗ).

Although any distribution can be used for p(wₛₗ), the Gaussian distribution is used to obtain the following.

[Math. 10]

wᵥₛₗ˜ [symbol] (wᵥₛₗ|w̅ₛₗ,η²) (10)

Here, −wₛₗ and η² are hyperparameters of the prior distribution to the mixing coefficient. For the convenience in the description of texts in the specification, symbols placed at the beginning of letters are listed before the letters, such as “−Wₛₗ.”

Next, the observation model for aggregated data is described. The observation model is an observation model which expresses the value of the aggregated data by the realization value of the Gaussian distribution having the integral value of the Gaussian process in the corresponding region as an average. Since a similar model is used for v=1, . . . , V, formulation for the v-th domain will be described. The observation vector of the N_{VS} dimension generated from the s-th Gaussian process is represented a yᵥₛ=(yᵥₛₗ, . . . , yᵥₛNᵥₛ)^{T}, and the observation vectors generated from the S Gaussian processes are collected as follows.

$$\begin{matrix}[ Math . 11 ] & \\ {y}_{v} = ( \begin{matrix}\begin{matrix}\begin{matrix}{y}_{v 1} \\ {y}_{v 2}\end{matrix} \\ ⋮\end{matrix} \\ {y}_{v S}\end{matrix} ) & ( 11 )\end{matrix}$$

It is assumed that yᵥ follows a multidimensional Gaussian distribution.

[Math. 12]

yᵥ|fᵥ(x)˜ [symbol] (yᵥ|∫_{X}_{ᵥ}Aᵥ(x)fᵥ(x)dx,Σᵥ) (12)

Here, A(x):Xᵥ→R^{N}^{_{v×s}}, with Nᵥ=E^{S}ₛ₌₁Nᵥₛ as follows.

$$\begin{matrix}[ Math . 13 ] & \\ {A}_{v} ( x ) = ( \begin{matrix}{a}_{v 1} ( x ) & 0 & … & 0 \\ 0 & {a}_{v 2} ( x ) & … & 0 \\ ⋮ & ⋮ & ⋱ & ⋮ \\ 0 & 0 & … & {a}_{vS} ( x )\end{matrix} ) & ( 13 )\end{matrix}$$

Here, aᵥₛ(x)=(aᵥₛₗ(x)), . . . , a_{vsNvs}(x))^{T}. For the convenience of description in the specification, a_{vsNvs}(x) is written, but with respect to the “vsNᵥₛ” this is intended to be “vsNᵥₛ” with a subscript a. An arbitrary one can be used as the aᵥₛₙ(x), and the way of aggregation in each region can be changed according to the way of setting the aᵥₛₙ(x). Here, it is considered that observation is obtained as a result of area averaging in each area Rᵥₛₙ. In so doing, aᵥₛₙ(x) is written as follows.

$$\begin{matrix}[ Math . 14 ] & \\ {a}_{vsn} ( x ) = \frac{( x ∈ {vsn}_{} )}{{\int }_{{X}_{v}} ( {x}^{′} ∈ {vsn}_{} ) {dx}^{′}} & ( 14 )\end{matrix}$$

Note that 1(⋅) is an indicator function, and when C is true, 1(C)=1 is output, and otherwise 1(C)=0 is output. Furthermore, the following can be obtained,

$$\begin{matrix}[ Math . 15 ] & \\ {Σ}_{v} = ( \begin{matrix}{σ}_{v 1}^{2} I & O & … & O \\ O & {σ}_{v 2}^{2} I & … & O \\ ⋮ & ⋮ & ⋱ & ⋮ \\ O & O & … & {σ}_{vS}^{2} I\end{matrix} ) & ( 15 )\end{matrix}$$

where σ²ᵥₛ is a noise dispersion parameter for the s-th data. Here, I is a unit matrix, and O is a matrix having all elements set to 0.

A method for learning various parameters will be described next. When it is assumed that observation data is generated from the Gaussian process model (observation model) of the equation (12), log marginal likelihood can be described as follows.

$$\begin{matrix}[ Math . 16 ] & \\ ln p ( \{ {y}_{v} \} ) = ln {\prod }_{v} \int \int p ( {y}_{v} , {W}_{v} , {f}_{v} ( x ) ) {df}_{v} ( x ) {dW}_{u} & ( 16 )\end{matrix}$$

$$\begin{matrix}[ Math . 17 ] & \\ = {\sum }_{v} ln \int [ \int p ( {y}_{v} \vert {W}_{v} , {f}_{v} ( x ) ) p ( {f}_{v} ( x ) ) {df}_{v} ( x ) ] p ( {W}_{v} ) {dW}_{v} & ( 17 )\end{matrix}$$

$$\begin{matrix}[ Math . 18 ] & \\ = {\sum }_{v} ln \int p ( {y}_{v} \vert {W}_{v} ) p ( {W}_{v} ) {dW}_{v} & ( 18 )\end{matrix}$$

Here, the following analytical calculation is possible.

[Math. 19]

p(pᵥ|Wᵥ)= [symbol] (yᵥ|0,Cᵥ) (19)

Further, Cᵥ is a correlation matrix of Nᵥ×Nᵥ, as follows.

[Math. 20]

Cᵥ=∫∫_{X}_{ᵥ}_{×X}_{ᵥ}Aᵥ(x)Kᵥ(x,x′)Aᵥ(x′)^{T}dxdx′+Σᵥ (20)

Calculation of the double integral in the equation (20) will be described. In the case where the number of dimensions of the input space Xᵥ is d=1, analytical calculation can be performed by a method similar to that of NPL 3. If d>1, since it is difficult to analytically calculate the integral, Discrete approximation is performed by the same method as in NPL 2 and numerical calculation is performed. The p(Wᵥ) in the equation(18) is as follows.

$$\begin{matrix}[ Math . 21 ] & \\ p ( {W}_{v} ) = {\prod }_{s , l} ( {w}_{vsl} \vert {\overline{w}}_{sl ,} {η}^{2} ) & ( 21 )\end{matrix}$$

Solutions for various parameters can be obtained by maximizing the equation (18). Here, since the integration of Wᵥ cannot be analytically performed, an arbitrary approximation method is used. For example, numerical approximation, Monte Carlo approximation, variational approximation, etc. can be used. As a method for maximizing the objective function after approximation, an arbitrary continuous optimization method can be used. For example, it can be solved using the BFGS method.

A case of approximating the integral of W, in the equation(18) using variational approximation will be described hereinafter. This method is called the variational Bayesian method. In the variational Bayesian method, the evidence lower bound of the equation(18) is calculated, and parameter estimation is performed using it as an objective function. The evidence lower bound can be described as follows by using the Jensen's inequality.

$$\begin{matrix}[ Math . 22 ] & \\ ln p ( \{ {y}_{v} \} ) \geq {\sum }_{v} \int Q ( {W}_{v} ) ln \frac{p ( {y}_{v} \vert {W}_{v} ) p ( {W}_{v} )}{Q ( {W}_{v} )} {dW}_{v} & ( 22 )\end{matrix}$$

$$\begin{matrix}[ Math . 23 ] & \\ = {\sum }_{v} 𝔼 [ ln p ( {y}_{v} \vert {W}_{v} ) ] - KL [ Q ( {W}_{v} ) ‖ p ( {W}_{v} ) ] & ( 23 )\end{matrix}$$

Here, Q(Wᵥ) is called the proposal distribution and is introduced to approximate the posterior distribution of Wᵥ. Q(Wᵥ) can be set to any probability distribution, but for simplicity, it is assumed that each element wᵥₛₗ of Wᵥ follows an independent Gaussian distribution. Such approximation is called average field approximation and expressed as follows.

$$\begin{matrix}[ Math . 24 ] & \\ Q ( {W}_{v} ) = {\prod }_{s , l} ( {w}_{vsl} \vert {\overline{w}}_{vsl}^{′} , {η}_{vsl}^{′2} ) & ( 24 )\end{matrix}$$

Here, −w′ᵥₛₗ and η′ᵥₛₗ² are variational parameters. At this time, although the KL divergence in the second term of the equation 23 can be calculated analytically, it is difficult to analytically calculate the expected value of the first term. Therefore, approximation using sampling is performed as follows.

[Math. 25]

[symbol]

[ln p(yᵥ|Wᵥ)]=∫Q(Wᵥ)ln p(yᵥ|Wᵥ)dWᵥ (25)

[Math. 26]

≈In p(yᵥ|Ŵᵥ). (26)

Here, \hat{ }Wᵥ to Q(Wᵥ). In addition, in order to enable the estimation of the variational parameter, the respective components of the \hat{ }Wᵥ are obtained as follows by using the Reparameterization trick as in NPL 1.

[Math. 27]

ŵᵥₛₗ=w̅′ᵥₛₗ+ϵ·η′ᵥₛₗ² (27)

where ε to N(0, 1).

As described above, the parameter estimation unit 6 performs calculation for estimating various parameters so as to maximize the equation (23), to obtain various parameters. For the maximization, any continuous optimization technique can be used.

The parameters to be estimated by the parameter estimation unit 6 are summarized as follows.
Spatial scale parameters {β₁|1=1, . . . , L}
Mixing coefficient {Wᵥ|v=1, . . . , V}
Parameters for noise {αᵥₛ|v=1, . . . , V; s=1, . . . S] and {kᵥₛ|v=1, . . . , V; s=1, . . . , S} and {Σᵥ|v=1, . . . , V}
Hyperparameter of prior distribution {−wₛₗ|s=1, . . . , S; l=1, . . . , L) and η²

Note that the variation parameters function as auxiliary variables for estimating the parameters described above, and are not used in the high-resolution data calculation unit 11 described later. The estimated parameters are stored in each of the following storage units. It is also possible to provide only one storage unit for storing a plurality of parameters.

### <Spatial Scale Parameter Storage Unit 7>

The spatial scale parameter storage unit 7 stores {β₁|1=1, . . . , L} obtained by the parameter estimation unit 6. The spatial scale parameter storage unit 6 can be any area where this information can be saved and restored. For example, the spatial scale parameter storage unit 6 may be a database or a specific area of a provided general-purpose storage device (memory or hard disk device).

### <Mixing Coefficient Storage Unit 8>

The mixing coefficient storage unit 8 stores the {Wᵥ|v=1, . . . , V} obtained by the parameter estimation unit 6. The mixing coefficient storage unit 8 can be any area where this information can be saved and restored. For example, the mixing coefficient storage unit 8 may be a database or a specific area of a provided general-purpose storage device (memory or hard disk device).

### <Parameter Storage Unit 9 for Noise>

The parameter storage unit 9 for noise stores {αᵥₛ|v=1, . . . V; s=1, . . . , S}, {Kᵥₛ|v=1, . . . , V; s=1, . . . , S}, and {Σᵥ|v=1, . . . , V} that are obtained by the parameter estimation unit 6. The parameter storage unit 9 for noise can be any area where this information can be saved and restored. For example, the parameter storage unit 9 for noise may be a database or a specific area of a provided general-purpose storage device (memory or hard disk device).

### <Hyperparameter Storage Unit 10 of Prior Distribution>

The hyperparameter storage unit 10 of the prior distribution stores {−wₛₗ|s=1, . . . , S; 1=1, . . . , L}, and η² that are obtained by the parameter estimation unit 6. The hyperparameter storage unit 10 of the prior distribution can be any area where this information can be saved and restored. For example, the hyperparameter storage unit 10 of the prior distribution may be a database or a specific area of a provided general-purpose storage device (memory or hard disk device).

The high-resolution data calculation unit 11 calculates high-resolution data by using the parameters stored in the respective storage units described above. The contents of processing performed by the high-resolution data calculation unit 11 will be described below.

### <High-Resolution Data Calculation Unit 11>

The high-resolution data calculation unit 11 calculates high-resolution data by using various learned parameters for the aggregated data designated by the retrieval unit 4 and the target division, and delivers the high-resolution data to the output unit 12. A method for calculating high-resolution data be described in detail below. Since the posterior distribution can be derived in the same manner regardless of the domain, the v-th domain will be described below. First, the posterior process for the S-variate Gaussian process fᵥ(x) of the v-th domain is derived. The posterior process f*ᵥ(x) is written as follows.

[Math. 28]

f*ᵥ(x)˜ [symbol] (m*ᵥ(x),K*ᵥ(x,x′)) (28)

where m*ᵥ(x):Xᵥ->R³ an average vector, and K*ᵥ(x, x′):Xᵥ×Xᵥ->R^{3×3} represents a correlation matrix. Next, H_{V}(x):Xᵥ->R^{Nvxs} is placed as follows.

[Math. 29]

Hᵥ(x)=∫_{X}_{ᵥ}Aᵥ(x′)Kᵥ(x′,x)dx′ (29)

Hᵥ(x) can be used to describe the following equation.

[Math. 30]

m*ᵥ(x)=Hᵥ(x)^{T}Cᵥ⁻¹yᵥ, (30)

[Math. 31]

K*ᵥ(x,x′)=Kᵥ(x,x′)−Hᵥ(x)^{T}Cᵥ⁻¹Hᵥ(x′) (31)

The high-resolution data calculation unit 11 calculates target high-resolution data by integrating the posterior average (30) in each region R^{target} included in the target division P^{target}.

### <Output Unit 12>

The output unit 12 outputs the high-resolution data on the basis of the information from the high-resolution data calculation unit 11. Here, “output” is a concept that includes displaying on a display device, printing by a printer, audio output, transmission to an external device, and the like. The output unit 12 may be conceived as including or not including an output device such as a display or a speaker. The output unit 12 can be realized by driver software of an output device, driver software of an output device and the output device, or the like.

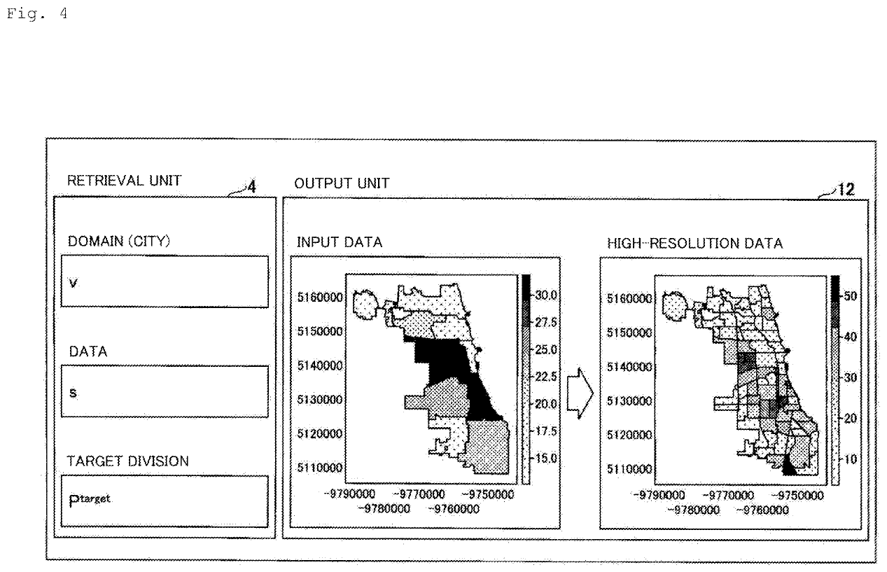

An output example is shown in FIG. 4. The argument of the target domain, the argument of the aggregated data, and the target division are received from the retrieval unit 3, and the output unit 12 displays the visualization result of the high-resolution data.

The density in the visualization result is determined, for example, in proportion to the data value. By using such an output example, it can be utilized for investigation for narrowing down in detail, for example, a region having high poverty or a region having high air pollution, to perform more appropriate intervention.

### Effects of Embodiments

As described above, in the present embodiment, since the prior distribution for the parameter (mixing coefficient) representing the dependence between data is introduced and the parameter estimation is performed in consideration of the prior distribution, various types of data in a plurality of domains can be utilized to achieve highly accurate prediction of high-resolution data while simultaneously estimating the similarity between the domains.

### (Notes)

The present specification discloses, at least, a parameter estimation device, an aggregated data resolution enhancement device, a parameter estimation method, an aggregated data resolution enhancement method, and a program according to each of the following clauses.

### (Clause 1)

A parameter estimation device for estimating a plurality of parameters used for calculating high-resolution data from aggregated data aggregated to coarse granularity, the parameter estimation device comprising: a parameter estimation unit configured to estimate a plurality of parameters that are unknown variables in a model so as to maximize a marginal likelihood based on the assumption that actually observed aggregated data is generated from the model based on a multivariate Gaussian process in which a plurality of latent Gaussian processes for a plurality of types of aggregated data in a plurality of domains are represented by linear mixing; and a storage unit configured to store the plurality of parameters, wherein the plurality of parameters include a hyperparameter of a prior distribution to a mixing coefficient used in the linear mixing.

### (Clause 2)

The parameter estimation device according to clause 1, wherein the model is a model in which a value of aggregated data of each region in a plurality of regions obtained by dividing a space of a domain with an integrated value of a multivariate Gaussian process in the region is modeled.

### (Clause 3)

The parameter estimation device according to clause 1 or clause 2, wherein the parameter estimation unit estimates the plurality of parameters by using a variation Bayesian method.

### (Clause 4)

An aggregated data resolution enhancement device, comprising a high-resolution data calculation unit that calculates high-resolution data from the aggregated data by using the plurality of parameters estimated by the parameter estimation device according to any one of clauses 1 to 3.

### (Clause 5)

An aggregated data resolution enhancement device for calculating high-resolution data from aggregated data aggregated into coarse granularity, the aggregated data resolution enhancement device comprising: a parameter estimation unit configured to estimate a plurality of parameters that are unknown variables in a model so as to maximize a marginal likelihood based on the assumption that actually observed aggregated data is generated from the model based on a multivariate Gaussian process in which a plurality of latent Gaussian processes for a plurality of types of aggregated data in a plurality of domains are represented by linear mixing; a storage unit configured to store the plurality of parameters; and a high-resolution data calculation unit configured to calculate high-resolution data from the aggregated data, wherein the plurality of parameters include a hyperparameter of a prior distribution to a mixing coefficient used in the linear mixing.

### (Clause 6)

A parameter estimation method that is executed by a parameter estimation device configured to estimate a plurality of parameters used for calculating high-resolution data from aggregated data aggregated into coarse granularity, the parameter estimation method comprising the steps of: estimating a plurality of parameters that are unknown variables in a model so as to maximize a marginal likelihood based on the assumption that actually observed aggregated data is generated from the model based on a multivariate Gaussian process in which a plurality of latent Gaussian processes for a plurality of types of aggregated data in a plurality of domains are represented by linear mixing; and storing the plurality of parameters in a storage unit, wherein the plurality of parameters include a hyperparameter of a prior distribution to a mixing coefficient used in the linear mixing.

### (Clause 7)

An aggregated data resolution enhancement method that is executed by an aggregated data resolution enhancement device for calculating high-resolution data from aggregated data aggregated into coarse granularity, the aggregated data resolution enhancement method comprising the steps of: estimating a plurality of parameters that are unknown variables in a model so as to maximize a marginal likelihood based on the assumption that actually observed aggregated data is generated from the model based on a multivariate Gaussian process in which a plurality of latent Gaussian processes for a plurality of types of aggregated data in a plurality of domains are represented by linear mixing; storing the plurality of parameters in a storage unit; and calculating high-resolution data from the aggregated data, wherein the plurality of parameters include a hyperparameter of a prior distribution to a mixing coefficient used in the linear mixing.

### (Clause 8)

A program for causing a computer to function as each of the units of the parameter estimation device as described in any one of clauses 1 through 3, or a program for causing a computer to function as each of the units of the aggregated data resolution enhancement device as described in clause 5.

The embodiment has been described above, but the present invention is not limited to the specific embodiment; various modifications and changes can be made within the scope of the gist of the present invention described in the claims.

### REFERENCE SIGNS LIST

100 Aggregated data resolution enhancement device
1 Aggregated data storage unit
2 Target division storage unit
3 Operation unit
4 Retrieval unit
5 High-resolution data processing unit
6 Parameter estimation unit
7 Spatial scale parameter storage unit
8 Mixing coefficient storage unit
9 Parameter storage unit for noise
10 Hyperparameter storage unit of prior distribution
11 High-resolution data calculation unit
12 Output unit
1000 Drive device
1001 Recording medium
1002 Auxiliary storage device
1003 Memory device
1004 CPU
1005 Interface device
1006 Display device
1007 Input device

1. A parameter estimation apparatus for estimating a plurality of parameters used for calculating high-resolution data from aggregated data aggregated to coarse granularity, the parameter estimation apparatus comprising:
a processor; and
a memory that includes instructions, which when executed, cause the processor to execute;
estimating by a parameter estimation unit, a plurality of parameters that are unknown variables in a model so as to maximize a marginal likelihood based on the assumption that actually observed aggregated data is generated from the model based on a multivariate Gaussian process in which a plurality of latent Gaussian processes for a plurality of types of aggregated data in a plurality of domains are represented by linear mixing; and
storing, by a storage unit, the plurality of parameters, wherein the plurality of parameters include a hyperparameter of a prior distribution to a mixing coefficient used in the linear mixing.

2. The parameter estimation apparatus according to claim 1, wherein the model is a model in which a value of aggregated data of each region in a plurality of regions obtained by dividing a space of a domain with an integrated value of a multivariate Gaussian process in the region is modeled.

3. The parameter estimation apparatus according to claim 1, wherein the parameter estimation unit estimates the plurality of parameters by using a variation Bayesian method.

4. An aggregated data resolution enhancement apparatus, comprising:
a processor; and
a memory that includes instructions, which when executed, cause the processor to execute;
calculating, by a high-resolution data calculation unit, high-resolution data from the aggregated data by using the plurality of parameters estimated by the parameter estimation apparatus according to claim 1.

5. An aggregated data resolution enhancement apparatus for calculating high-resolution data from aggregated data aggregated into coarse granularity, the aggregated data resolution enhancement apparatus comprising:
a processor; and
a memory that includes instructions, which when executed, cause the processor to execute:
estimating, by a parameter estimation unit, a plurality of parameters that are unknown variables in a model so as to maximize a marginal likelihood based on the assumption that actually observed aggregated data is generated from the model based on a multivariate Gaussian process in which a plurality of latent Gaussian processes for a plurality of types of aggregated data in a plurality of domains are represented by linear mixing;
storing, by a storage unit, the plurality of parameters; and
calculating, by a high-resolution data calculation unit, high-resolution data from the aggregated data, wherein
the plurality of parameters include a hyperparameter of a prior distribution to a mixing coefficient used in the linear mixing.

6. A parameter estimation method that is executed by a computer in a parameter estimation apparatus configured to estimate a plurality of parameters used for calculating high-resolution data from aggregated data aggregated into coarse granularity, the parameter estimation method comprising:
estimating a plurality of parameters that are unknown variables in a model so as to maximize a marginal likelihood based on the assumption that actually observed aggregated data is generated from the model based on a multivariate Gaussian process in which a plurality of latent Gaussian processes for a plurality of types of aggregated data in a plurality of domains are represented by linear mixing; and
storing the plurality of parameters in a storage unit, wherein
the plurality of parameters include a hyperparameter of a prior distribution to a mixing coefficient used in the linear mixing.

7. (canceled)

8. A non-transitory computer-readable recording medium storing a program for causing a computer to function as each of the units of the parameter estimation apparatus as described in claim 1.

9. A non-transitory computer-readable recording medium storing a program for causing a computer to function as each of the units of the aggregated data resolution enhancement apparatus as described in claim 5.
